(19) United States
(12) Patent Application Publication
(10) Pub. No.: US 2024/0087391 A1
(43) Pub. Date: Mar. 14, 2024

(54) SYSTEM AND METHOD USING FRACTIONAL VOTING

(71) Applicant: BELADED INC, Houston, TX (US)

(72) Inventors: Fortune Vieyra, Miami Beach, FL (US); Gilbert Hippolyte, Miami Beach, FL (US)

(21) Appl. No.: 18/134,536

(22) Filed: Apr. 13, 2023

Related U.S. Application Data
(60) Provisional application No. 63/330,626, filed on Apr. 13, 2022.

(51) Int. Cl. G07C 13/00; G06Q 30/0214; G06Q 30/06; H04N 21/2187

(52) U.S. Cl. CPC G07C 13/00; G06Q 30/0214; G06Q 30/06; H04N 21/2187; G06Q 2230/00

(57) ABSTRACT

A system and method using fractional votes based on private priority messaging or based on games/shows is disclosed. The system and method include entering into an application, buying tokens in whole or parts, searching for a host or game/show, selecting the host or game/show, entering a priority token value, initiating a message for delivery, delivering the initiated message to the host based on priority token value, reviewing messages based on priority token value, placing the priority token value worth of tokens in escrow, performing a task associated with the message, and upon successfully responding and completing the task, paying the host a commission.

### CROSS REFERENCE TO RELATED APPLICATIONS

This application claims the benefit of U.S. Provisional Application No. 63/330,626, filed Apr. 13, 2022, which is incorporated by reference as if fully set forth.

### FIELD OF INVENTION

The present invention is directed to online interactions with games and shows. More particularly, the present invention is directed to a system and method for fractional voting for games and shows.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a block diagram of an example device in which one or more features of the disclosure can be implemented;

FIG. 2 is a block diagram of an example system for remotely interacting with other devices within the system of the present invention;

FIG. 3 is a system diagram of an example of a computing environment in communication with network according to one or more embodiments;

FIG. 4 illustrates a system for performing the activities of the present invention;

FIG. 5 illustrates a graphical depiction of the communication between an entity, such as a user, for example, and a host that may occur within the present system to achieve the methods described;

FIG. 6 illustrates a graphical depiction to illustrate the framework of the token configured to enable the system to utilizes tokens between an entity and a host;

FIG. 7 illustrates a graphical depiction of a token-based communication between an entity and a host in the system;

FIG. 8 illustrates a graphical depiction of a token-based announcement(s) where an entity 81 requests an available host to conduct an announcement;

FIG. 9 illustrates a graphical depiction of a token-based announcement(s) where an entity requests a host to conduct an announcement;

FIG. 10 illustrates a graphical depiction of a token-based voting where an entity provides a vote;

FIG. 11 illustrates a depiction of a method or flow using fractional votes based on private priority messaging;

FIG. 12 illustrates a depiction of a method or flow of the present system using fractional votes based on games and shows; and

FIG. 13 illustrates a depiction for a method and flow on a system using fractional votes based on gifts and tips.

### DETAILED DESCRIPTION

In an era where fractional units are a utility, the fractional vote can be associated with a currency: crypto, or fiat. In a case where votes are a utility based on a currency, voting where individual units are currency based creates a limitation on who gets to vote and how much they get to vote. Fractional voting allows more people to vote. Opens voting opportunities to more people and reduces the cost of voting from original unit to fractional unit value.

Votes might also be associated with a utility exchange such as barter. One value for another value. Any measurable unit of value. For example, to exchange 10 minutes of time for 10 minutes of the time of another where 5 vote units=10 minutes or time factor—30 votes=1 hour. Fractional votes are the same thing but as a fraction.

The present system and method for fractional voting units focuses on the creation of voting units, the utilization of the units, the transfer of the units, and the life cycle and life span of the units. The system is able to create voting units using one or more utility factors, including currency, value, time, demand, resources, such as virtual real estate, or such as space on the application, for example.

In a currency-based system, another currency such as fiat (US Dollars, others) may be accepted and converted to a vote/token. The value of a vote/token 1 unit/token=1 dollar/any value created by the system. The fractional voting unit=fraction of a dollar/value created. For example, fraction 0.25 cent=0.25 voting units/token. Users may purchase the tokens and are able to break down voting in whole or fractional units. For example, Cashapp, Robinhood—both have a fractional purchase of stocks for fractional value in the marketplace.

The present system and method apply a similar concept of fractional units without the tokens/units being limited to currency. The present system and method utilizes a value—exchange of services of products. The system supports a user creating a service and assigning a value to the service based on value of the units/tokens. A user can assign an NFT that is, in whole or fractional voting units, as the digital or physical good. Two or more people can exchange services or goods based on whole and fractional voting units, such as through a website that supports creating the unit of values, such as an NFT or service and publishing that service/good in that marketplace.

In a time-based system, the system supports creating fractional voting units based off of time allocated towards something, such as digital based on a time-based event: video call, phone call. Voting units can be a measure of 1 unit=1 minute, 0.50 units=30 seconds, for example. Ex., 1 vote=1 second 0.50=500 milliseconds

In a demand-based system, the system is able to create voting units based on the demand for something or any metric that uses a numerical or named classification and can have a derived voting unit applied to it. For example, demand for a product is at 50 k people=voting unit 50 thousand. For example, website traffic for ABC.com is 100 k daily visitors=100 voting units where one voting unit=1000-page views and fractional=500-page views=50 k, for example.

The present system and method allow for tokens to be allocated for other purposes aside from advertising and not using it for the purpose of biding for ad spaces. The present system and method are using tokens effectively as a utility in multiple areas, such as voting, impressions, communication services, product and exchanging values of any measure. The present system and method are not limited to advertising networks or advertising services that use demand as a unit of value. The present system and method maximize the utility of our units for other purposes. The present system and method operate with any unit being fixed or elastic and can be directly associated with one or more metric, such as a multipurpose utility-oriented token, for example. For example, page views and time on site may be separate metrics. Page views and time on site may be combined to form a voting unit for visitor engagement referred to as a engagement voting unit.

Within the framework of the provided description, the fractional voting units system and method may be employed including using fractional votes as a fraction of the value of paid votes. In general, systems operate with single unit value not fractional votes, such as political votes, group consensus made based on single value votes, for example.

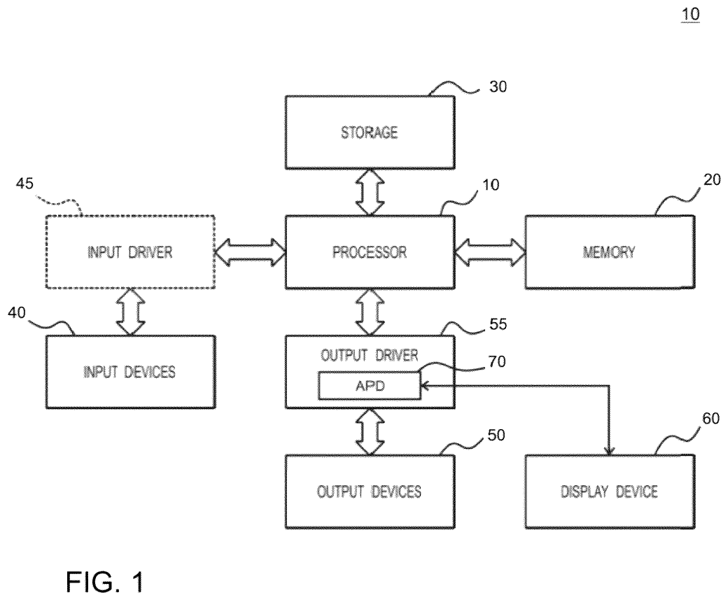

FIG. 1 is a block diagram of an example, device 1 in which one or more features of the disclosure can be implemented. The device 1 can include, for example, a computer, a gaming device, a handheld device, a set-top box, a television, a mobile phone, server, a tablet computer or other types of computing devices. The device 1 includes a processor 10, a memory 20, a storage 30, one or more input devices 40, and one or more output devices 50. The device 1 can also optionally include an input driver 45 and an output driver 55. It is understood that the device 1 can include additional components not shown in FIG. 1.

In various alternatives, the processor 10 includes a central processing unit (CPU), a graphics processing unit (GPU), a CPU and GPU located on the same die, or one or more processor cores, wherein each processor core can be a CPU or a GPU. In various alternatives, the memory 20 is located on the same die as the processor 10, or is located separately from the processor 10. The memory 20 includes a volatile or non-volatile memory, for example, random access memory (RAM), dynamic RAM, or a cache.

The storage 30 includes a fixed or removable storage, for example, a hard disk drive, a solid-state drive, an optical disk, or a flash drive. The input devices 40 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 50 include, without limitation, a display device 60, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 45 communicates with the processor 10 and the input devices 40, and permits the processor 10 to receive input from the input devices 40. The output driver 55 communicates with the processor 10 and the output devices 50, and permits the processor 10 to send output to the output devices 50. It is noted that the input driver 45 and the output driver 55 are optional components, and that the device 1 may operate in the same manner if the input driver 45 and the output driver 55 are not present. The output driver 55 may include an accelerated processing device (“APD”) 70 which is coupled to a display device 60. The APD accepts compute commands and graphics rendering commands from processor 10, processes those compute and graphics rendering commands, and provides pixel output to display device 60 for display. As described in further detail below, the APD 70 includes one or more parallel processing units to perform computations in accordance with a single-instruction-multiple-data (“SIMD”) paradigm. Thus, although various functionality is described herein as being performed by or in conjunction with the APD 70, in various alternatives, the functionality described as being performed by the APD 70 is additionally or alternatively performed by other computing devices having similar capabilities that are not driven by a host processor (e.g., processor 10) and provides graphical output to a display device 60. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

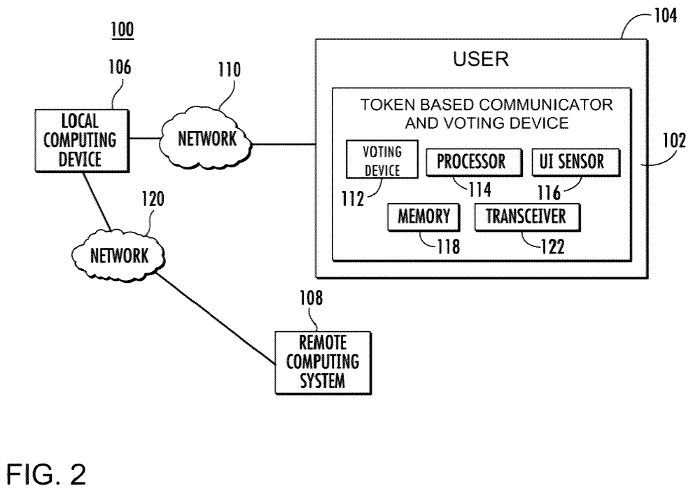

FIG. 2 is a block diagram of an example system for remotely interacting with other devices within the system of the present invention. In the example illustrated in FIG. 2, the system 100 includes a token-based communicator and voting device 102 associated with a user 104, a local computing device 106, a remote computing system 108, a first network 110, a voting device 112, a processor 114, a user input (UI) sensor 116, a memory 118, a second network 120, and a transmitter-receiver (i.e., transceiver) 122.

According to an embodiment, the token-based communicator and voting device 102 may be an apparatus that useable by a user to provide input and feedback related to a display that is configured on the token-based communicator and voting device 102 or external to the token-based communicator and voting device 102, such as the device 10 of FIG. 1. The token-based communicator and voting device 102 may be handheld by a user and may include feedback devices and sensors configured to allow the user to provide feedback, such as by voting, for example. Additionally, the token-based communicator and voting device 102 may be configured to include devices that allow the user to watch video, live streams, for example. The token-based communicator and voting device 102 may include a display.

According to an embodiment, the token-based communicator and voting device 102 may be an apparatus that is external to the viewing device, such as a separate computing device from the display. For example, as described in more detail below, the token-based communicator and voting device 102 may include an phone, or computing device. The token-based communicator and voting device 102 may also include a display, an interactive screen, or the like, capable of receiving user input.

According to an embodiment, the token-based communicator and voting device 102 may include both components that are internal to the user display of the video and components that are external to the user display of the video.

The single token-based communicator and voting device 102 is shown in FIG. 2. Example systems may, however, may include a plurality of token-based communicator and voting apparatuses. A token-based communicator and voting apparatus may be in communication with one or more other token-based communicator and voting apparatuses. Additionally or alternatively, token-based communicator and voting apparatus may be in communication with the network 110.

One or more token-based communicator and voting apparatuses 102 may acquire user input (e.g., voting, token purchase, token spend, notification, communication from others users, communication from hosts, and recommendations) and receive at least a portion of video and communications representing the live stream or video associated with a user selection from one or more other token-based communicator and voting apparatuses 102. The additional information may be, for example, voting, token purchase, token spend, notification, communication from others users, communication from hosts, and recommendations. Each of the token-based communicator and voting device 102 may process data, including its own acquired voting, token purchase, token spend, notification, communication from others users, communication from hosts, and recommendations as well as voting, token purchase, token spend, notification, communication from others users, communication from hosts, and recommendations received from one or more other token-based communicator and voting apparatuses 102.

In FIG. 2, the network 110 is an example of a short-range network (e.g., local area network (LAN), or personal area network (PAN)). Information may be sent, via the network 110, between the token-based communicator and voting device 102 and the local computing device 106 using any one of various short-range wireless communication protocols, such as Bluetooth, Wi-Fi, Zigbee, Z-Wave, near field communications (NFC), ultraband, Zigbee, or infrared (IR).

The network 120 may be a wired network, a wireless network or include one or more wired and wireless networks. For example, the network 120 may be a long-range network (e.g., wide area network (WAN), the internet, or a cellular network). Information may be sent, via the network 120 using any one of various long-range wireless communication protocols (e.g., TCP/IP, HTTP, 3G, 4G/LTE, or 5G/New Radio).

The token-based communicator and voting device 102 may include the voting device 112, the processor 114, the UI sensor 116, the memory 118, and the transceiver 122. The token-based communicator and voting device 102 may continually or periodically monitor, store, process and communicate, via the network 110, any number of various electronic media and communication methods. Examples of electronic media include videos, video shorts, TikTok, reels, YouTube, Instagram, Facebook, music, phone ring tones, screen savers, text messages and alerts, vibration mechanisms, lighting probes and alerts, and the like. Examples of communications messages include live chat, SMS messages, audio and/or video phone calls, and the like, that may be monitored into to provide interaction with the systems of the present invention.

The voting device 112 may include, for example, one or more sensors configured to sense a type of input from a user. For example, the voting device 112 may include an electrode configured to acquire electrical signals or a temperature sensor, that provide input into the video viewing system. As described in more detail below, the token-based communicator and voting device 102 may be a voting tracker and may provide accounting for token management. The voting device 112 may include one or more inputs for acquiring user inputs in voting. The voting signals (votes) may be used to provide hosts information certain tasks to perform.

In another example, the token-based communicator and voting device 102 may be a wearable device. The wearable device may monitor signals from the user based on the reaction to video being viewed on a screen display and this data may be sent to a host for action without user intervention.

The transceiver 122 may include a separate transmitter and receiver. Alternatively, the transceiver 122 may include a transmitter and receiver integrated into a single device.

The processor 114 may be configured to store user interactions, such as voting in the memory 118 acquired by the voting device 112, and communicate the videos and other feedback, across the network 110, via a transmitter of the transceiver 122. Data from one or more other token-based communicator and voting device 102 may also be received by a receiver of the transceiver 122, as described in more detail below.

According to an embodiment, the token-based communicator and voting device 102 includes UI sensor 116 which may be, for example, a piezoelectric sensor or a capacitive sensor configured to receive a user input, such as a tapping or touching. For example, the UI sensor 116 may be controlled to implement a capacitive coupling, in response to tapping or touching a surface of the token-based communicator and voting device 102 by the user 104. Gesture recognition may be implemented via any one of various capacitive types, such as resistive capacitive, surface capacitive, projected capacitive, surface acoustic wave, piezoelectric and infra-red touching. Capacitive sensors may be disposed at a small area or over a length of the surface such that the tapping or touching of the surface activates the monitoring device.

As described in more detail below, the processor 114 may be configured to respond selectively to different tapping patterns of the capacitive sensor (e.g., a single tap or a double tap), which may be the UI sensor 116, such that different tasks of the patch (e.g., acquisition, storing, or transmission of data) may be activated based on the detected pattern. In some embodiments, audible feedback may be given to the user from the token-based communicator and voting device 102 when a gesture is detected.

The local computing device 106 of the system 100 is in communication with the token-based communicator and voting device 102 and may be configured to act as a gateway to the remote computing system 108 through the second network 120. The local computing device 106 may be, for example, a, smart phone, smartwatch, tablet or other portable smart device configured to communicate with other devices via the network 120. Alternatively, the local computing device 106 may be a stationary or standalone device, such as a stationary base station including, for example, modem and/or router capability, a desktop or laptop computer using an executable program to communicate information between the token-based communicator and voting device 102 and the remote computing system 108 via the PC's radio module, or a USB dongle. Voting, announcements, payments and video streams may be communicated between the local computing device 106 and the token-based communicator and voting device 102 using a short-range wireless technology standard (e.g., Bluetooth, Wi-Fi, ZigBee, Z-wave and other short-range wireless standards) via the short-range wireless network 110, such as a local area network (LAN) (e.g., a personal area network (PAN)). In some embodiments, the local computing device 106 may also be configured to display video, live streams, recorded live streams, a token bank, a voting questions, as described in more detail below.

In some embodiments, the remote computing system 108 may be configured to receive at least one of the votes, videos, tokens, and text associated with the users via network 120, which is a long-range network. For example, if the local computing device 106 is a mobile phone, network 120 may be a wireless cellular network, and information may be communicated between the local computing device 106 and the remote computing system 108 via a wireless technology standard, such as any of the wireless technologies mentioned above. As described in more detail below, the remote computing system 108 may be configured to provide (e.g., visually display and/or aurally provide) at least one of the votes, videos, tokens, and text to a host.

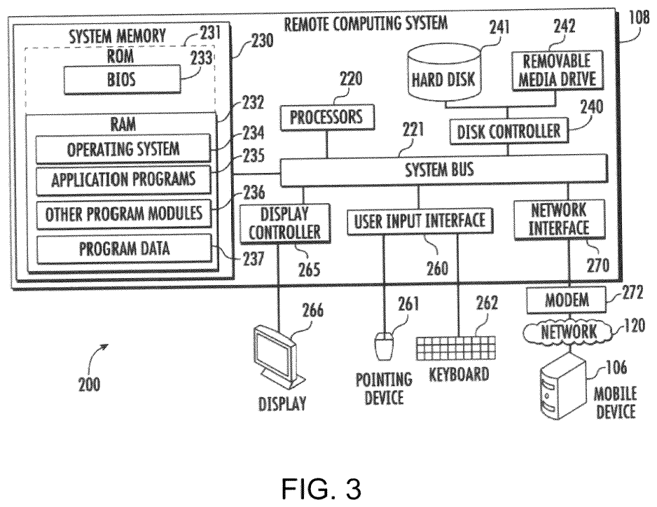

FIG. 3 is a system diagram of an example of a computing environment 200 in communication with network 120. In some instances, the computing environment 200 is incorporated in a public cloud computing platform (such as Amazon Web Services or Microsoft Azure), a hybrid cloud computing platform (such as HP Enterprise OneSphere) or a private cloud computing platform.

As shown in FIG. 3, computing environment 200 includes remote computing system 108 (hereinafter computer system), which is one example of a computing system upon which embodiments described herein may be implemented.

The remote computing system 108 may, via processors 220, which may include one or more processors, perform various functions. The functions may include providing video streams, analyzing and tabulating votes from users, receiving communications from users, providing output from a host and the associated information and, monitoring token related activities and parameters, providing (e.g., via display 266) alerts, additional information or instructions. As described in more detail below, the remote computing system 108 may be used to provide (e.g., via display 266) users and hosts with a videos and streams of activities and sporting events, such that such information may enable interaction with the videos, hosts and other users to add to the enjoyment of viewing.

As shown in FIG. 3, the computer system 210 may include a communication mechanism such as a bus 221 or other communication mechanism for communicating information within the computer system 210. The computer system 210 further includes one or more processors 220 coupled with the bus 221 for processing the information. The processors 220 may include one or more CPUs, GPUs, or any other processor known in the art.

The computer system 210 also includes a system memory 230 coupled to the bus 221 for storing information and instructions to be executed by processors 220. The system memory 230 may include computer readable storage media in the form of volatile and/or nonvolatile memory, such as read only system memory (ROM) 231 and/or random-access memory (RAM) 232. The system memory RAM 232 may include other dynamic storage device(s) (e.g., dynamic RAM, static RAM, and synchronous DRAM). The system memory ROM 231 may include other static storage device(s) (e.g., programmable ROM, erasable PROM, and electrically erasable PROM). In addition, the system memory 230 may be used for storing temporary variables or other intermediate information during the execution of instructions by the processors 220. A basic input/output system 233 (BIOS) may contain routines to transfer information between elements within computer system 210, such as during start-up, that may be stored in system memory ROM 231. RAM 232 may comprise data and/or program modules that are immediately accessible to and/or presently being operated on by the processors 220. System memory 230 may additionally include, for example, operating system 234, application programs 235, other program modules 236 and program data 237.

The illustrated computer system 210 also includes a disk controller 240 coupled to the bus 221 to control one or more storage devices for storing information and instructions, such as a magnetic hard disk 241 and a removable media drive 242 (e.g., floppy disk drive, compact disc drive, tape drive, and/or solid-state drive). The storage devices may be added to the computer system 210 using an appropriate device interface (e.g., a small computer system interface (SCSI), integrated device electronics (IDE), Universal Serial Bus (USB), or FireWire).

The computer system 210 may also include a display controller 265 coupled to the bus 221 to control a monitor or display 266, such as a cathode ray tube (CRT) or liquid crystal display (LCD), for displaying information to a computer user. The illustrated computer system 210 includes a user input interface 260 and one or more input devices, such as a keyboard 262 and a pointing device 261, for interacting with a computer user and providing information to the processor 220. The pointing device 261, for example, may be a mouse, a trackball, or a pointing stick for communicating direction information and command selections to the processor 220 and for controlling cursor movement on the display 266. The display 266 may provide a touch screen interface that may allow input to supplement or replace the communication of direction information and command selections by the pointing device 261 and/or keyboard 262.

The computer system 210 may perform a portion or each of the functions and methods described herein in response to the processors 220 executing one or more sequences of one or more instructions contained in a memory, such as the system memory 230. Such instructions may be read into the system memory 230 from another computer readable medium, such as a hard disk 241 or a removable media drive 242. The hard disk 241 may contain one or more data stores and data files used by embodiments described herein. Data store contents and data files may be encrypted to improve security. The processors 220 may also be employed in a multi-processing arrangement to execute the one or more sequences of instructions contained in system memory 230. In alternative embodiments, hard-wired circuitry may be used in place of or in combination with software instructions. Thus, embodiments are not limited to any specific combination of hardware circuitry and software.

As stated above, the computer system 210 may include at least one computer readable medium or memory for holding instructions programmed according to embodiments described herein and for containing data structures, tables, records, or other data described herein. The term computer readable medium as used herein refers to any non-transitory, tangible medium that participates in providing instructions to the processor 220 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 241 or removable media drive 242. Non-limiting examples of volatile media include dynamic memory, such as system memory 230. Non-limiting examples of transmission media include coaxial cables, copper wire, and fiber optics, including the wires that make up the bus 221. Transmission media may also take the form of acoustic or light waves, such as those generated during radio wave and infrared data communications.

The computing environment 200 may further include the computer system 210 operating in a networked environment using logical connections to local computing device 106 and one or more other devices, such as a personal computer (laptop or desktop), mobile devices (e.g., patient mobile devices), a server, a router, a network PC, a peer device or other common network node, and typically includes many or all of the elements described above relative to computer system 210. When used in a networking environment, computer system 210 may include modem 272 for establishing communications over a network 120, such as the Internet. Modem 272 may be connected to system bus 221 via network interface 270, or via another appropriate mechanism.

Network 120, as shown in FIGS. 2 and 3, may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., local computing device 106).

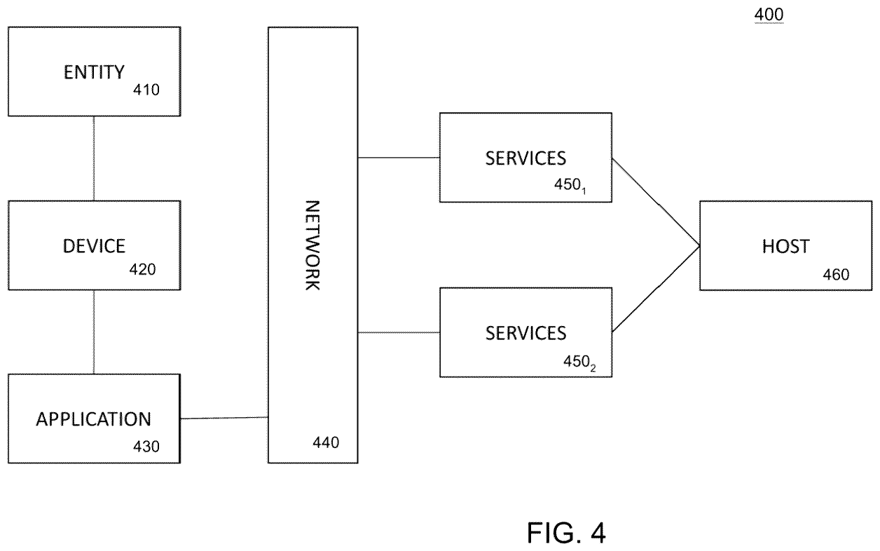

FIG. 4 illustrates a system 400 for performing the activities of the present invention. FIG. 4 illustrates an entity 410, which may take the form of a user, host, team, person and/or artificial intelligence bot, for example, using a device 420, such as a phone, computer, smart watch, web camera, virtual reality glasses, television, games console, headphones and or other applicable device, for example, to access and application 430, such as a browser, website, application and/or livestream, for example. This access may occur over a network 440 via servers (not shown), cloud network, database, WI FI and/or router with networks including cellular networks, satellite networks, wide area networks, cloud network, local area network, as would be understood. The entity 410, also referred to as a user, performs services 450₁, such as voting via clicks or other interactions, notifications, payments and tips, for example. The information associated with services 450₁ may be provided to a host 460. The entity 410 access services 450₂, such as announcements, messages, priority messages, live chats and video calls, for example, to interact with the host 460.

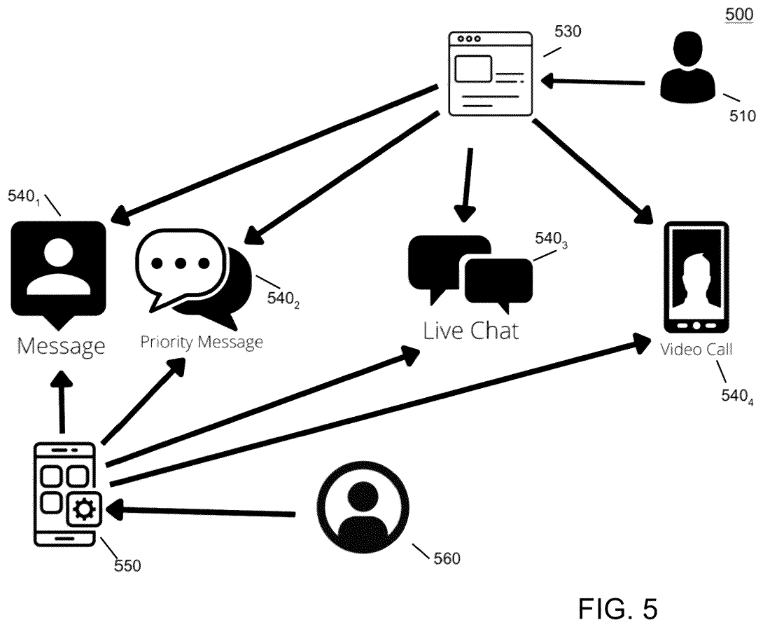

FIG. 5 illustrates a graphical depiction 500 of the communication between an entity 510, such as a user, for example, and a host 560 that may occur within the present system to achieve the methods described. Entity 510 may use an application 530 that connects via the network as described above. Entity 510 may utilize application 530 to access via one or more messages 540₁, one or more priority messages 540₂, one or more live chats 540₃ and/or one or more video calls 540₄ to communicate with host 560 via one or more applications 550.

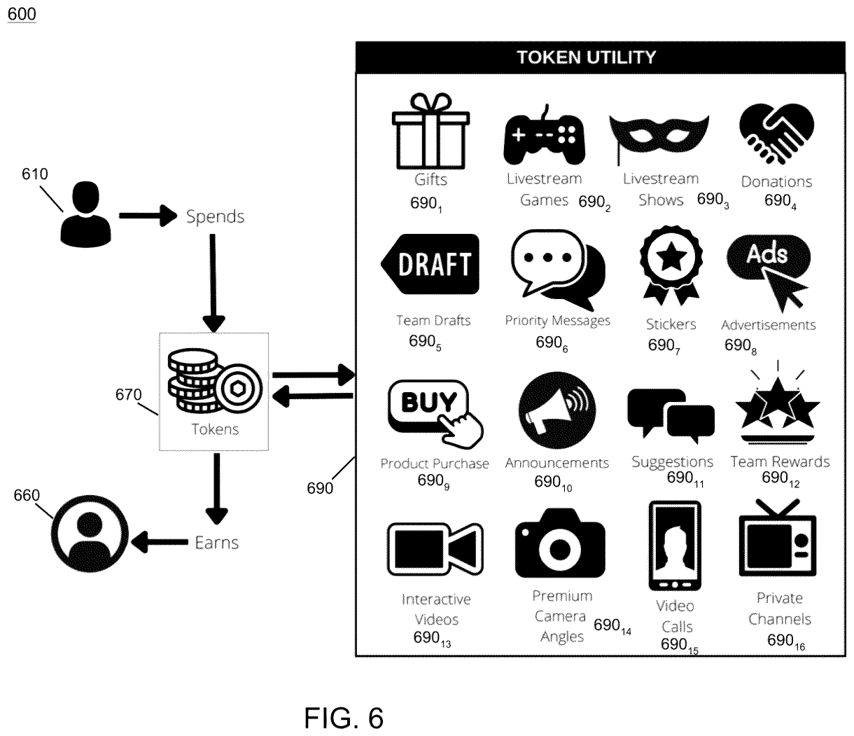

FIG. 6 illustrates a graphical depiction 600 to illustrate the framework of the token 670 configured to enable the system to utilizes tokens 670 between an entity 610 and a host 660. Entity 610 may acquire tokens 670 and may spend the acquired tokens 670 during interactions with the system. Entity 610 may acquire tokens by purchasing, performing activities within the system, such as by acting as a host or other entity in a different aspect of the system, for example, and/or may be given tokens by other entities within the system. Once acquired, tokens 670 may be used to acquire services within the present system. The acquired tokens 670 may be held and accounted for within the system.

When the entity exchanges the acquired tokens 670 for services with the system, in an aspect of the embodiment, tokens 670 may be held in a repository (not shown) until/while host 660 earns an allocated set of tokens 670 by performing the purchased activity. For example, if 10 tokens 670 are used to purchase an activity where the host 660 juggles without fail for 1 minutes. Those 10 tokens may be held in the repository until the activity is completed. Tokens 670 involved in the transaction may be removed from the account of entity 610 and transferred to host 660. There may be a period where the transacted tokens 670 are held in between accounts while host 660 performs the agreed activity.

In some embodiments, the activity may be one or more voting activities 690. One or more voting activities 690 may include, by way of example, one or more tips 690₁, one or more games 690₂, one or more priority messages 690₃, one or more team drafts 690₄, one or more shows 690₅, one or more live chats 690₆, one or more product producers 690₇, one or more premium camera angles 690₈, one or more video calls 690₉, one or more interactive videos 690₁₀, one or more announcements 690₁₁ and/or one or more stickers 690₁₂.

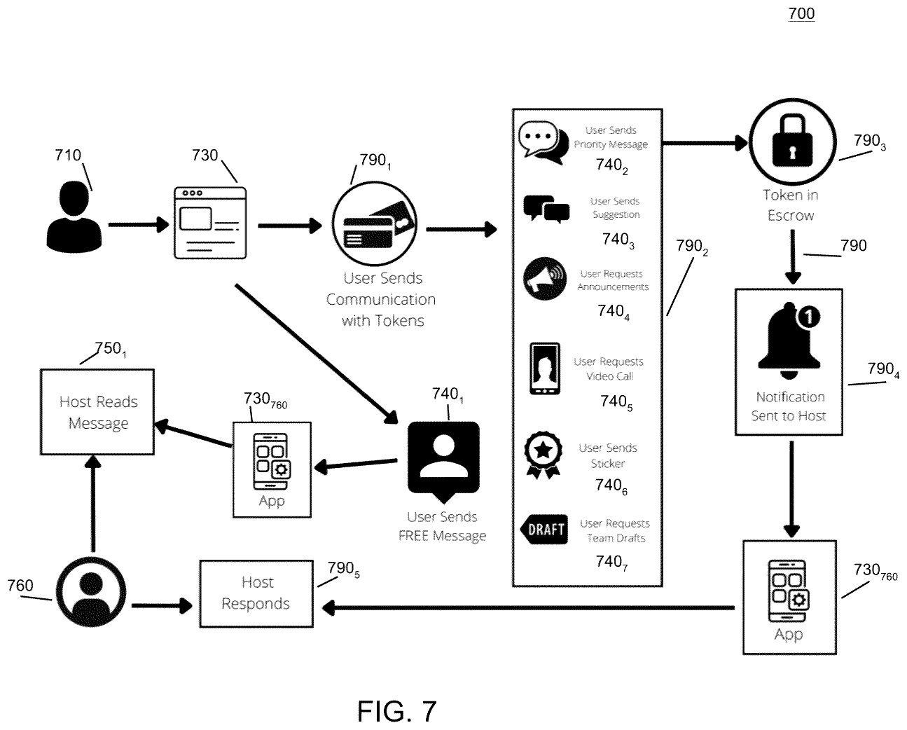

FIG. 7 illustrates a graphical depiction 700 of a token-based communication between an entity 710 and a host 760 in the system. As described above, the token-based communication may include one or more messages 740₁, 740₂, one or more chats 740₃ and/or one or more calls 740₄. The handling 750, 790 of the communication is explained further below.

In an example, the present system may include free messages, such as for example in FIG. 7 one or more messages 740₁. The free side handling 750 may include entity 710 accessing an application 730 to send one or more free messages 740₁. Host 760 may utilize a version of the application 730₇₆₀ to access the message, such as by reading the message 750₁. Host 760, although not specifically illustrated, may respond with one or more response messages, or may respond by converting the communication to one handled on the pay side handling 790.

On the pay side handling 790, entity 710 accesses the application 730 (which may be the same application or may be a different application) to send a communication 790₂, such as one or more messages 740₂, one or more chat requests 740₃, or one or more call requests 740₄ along with the tokens associated with the fee for the sent send one or more messages 740₂, one or more chat requests 740₃, or one or more call requests 740₄. The tokens associated with the fee may be held in escrow 790₃. A notification 790₄ is sent to the host, such as sent through the application 730₇₆₀ of the host 760. The host 760 may then respond 790₅.

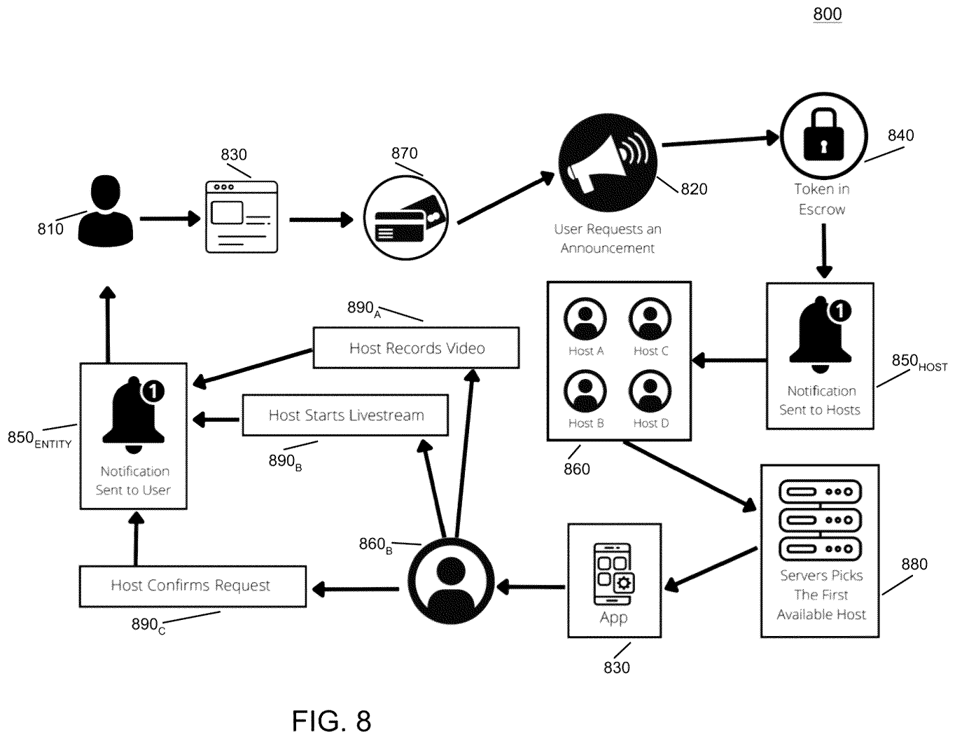

FIG. 8 illustrates a graphical depiction 800 of a token-based announcement(s) where an entity 810 requests an available host 860_{B} to conduct an announcement. Such an announcement may occur during livestream or recorded videos, for example. The token-based announcement is handled, as depicted in depiction 800, entity 810 accesses the application 830 (which may be the same application or may be a different application) to acquire tokens 870 to use to request an announcement 820. The tokens associated with the announcement may be held in escrow 840 while the performance of the announcement occurs. Once the request 820 is made, and the tokens are held in escrow 840, the host 860 is notified 850_{HOST}. A selection of the host 860 is made, such as based on availability, and the system may make the selection 880, from an available set of hosts, such as hosts A, host B, host C, host D (collectively hosts 860). A notification 880 is sent to the selected host, in the example host B 860_{B}. The notification 880 may be sent through the application 830 of the host B 860_{B}. The host B 860_{B} may then respond 890. For example, the notification 880 is sent to the host 860, with the server selecting 880 the first available host B 860_{B}. The host B 860_{B} records a video 890_{A} or stars in the live stream 890_{B}, while confirming the user requests at 890_{C}. The system notifies at 850_{ENTITY} the entity of the video recordation at 890_{A}, livestream 890_{B}, and the confirmation at 890_{C}.

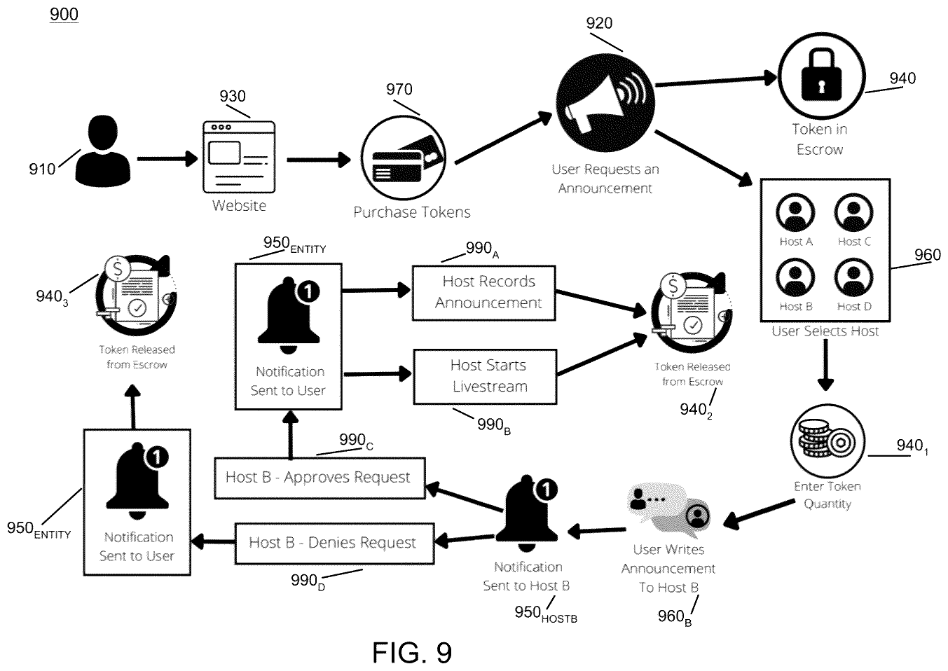

FIG. 9 illustrates a graphical depiction 900 of a token-based announcement(s) where an entity 910 requests an available host 860_{B} to conduct an announcement. Such an announcement may occur during livestream or recorded videos, for example. The token-based announcement is handled, as depicted in depiction 900, entity 910 accesses the application 930 (which may be the same application or may be a different application) to acquire tokens 970 to use to request an announcement 920. The tokens associated with the announcement may be held in escrow 940 while the performance of the announcement occurs. Once the request 920 is made, and in parallel with the tokens being held in escrow 940, the host 960 is contacted and a token quantity 940₁ is provided for recording the announcement by the host 960. Entity 910 provides the announcement at 960_{B} and the host 960 is notified 950_{HOST}. A selection of the host 960 is made, such as based on availability, and the entity 910 may make the selection from an available set of hosts, such as hosts A, host B, host C, host D (collectively hosts 960). The user selects and requests a specific host to conduct the announcement during livestream or recorded videos. If the selected host 960 denies the request at 990_{D} notification 950_{ENTITY} is provided to the entity 910 and the tokens are refunded at 940₃. The host 860 may approve the request 990C and notification 950_{ENTITY} is send to entity 910. After notifying the entity 910, the host 960 may record announcement 990_{A} and starts the livestream 990_{B} based on the agreed upon activities. The host records a video or stars in the live stream, confirms user requests and send notification to the users. Once completed the tokens may be released 940₂.

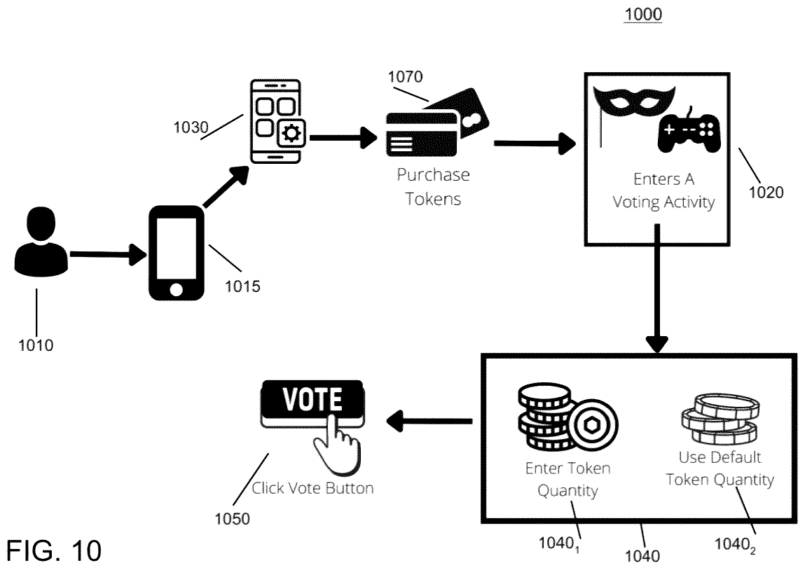

FIG. 10 illustrates a graphical depiction 1000 of a token-based voting where an entity 1010 provides a vote 1050. The voting uses tokens and is explained in an activity agnostic configuration. An entity 1010 uses a device 105 to access the application 1030 (which may be the same application or may be a different application) to acquire tokens 1070 to use to vote 1050. Entity 1010 enters voting activity 1020 and provides tokens 1040 to place a vote 1050. Providing tokens 1040 may include one or more of entering a token quantity 1040₁ and using a default token quantity 1040₂. Once the tokens are provided 1040 a vote 105 may be cast by entity 1010.

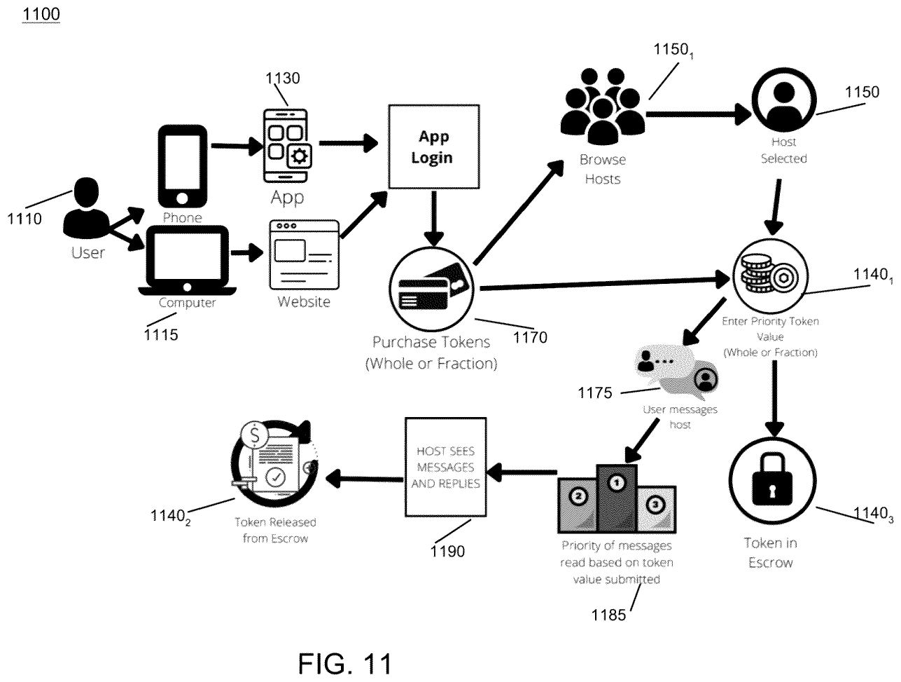

FIG. 11 illustrates a depiction 1100 of a method or flow using fractional votes based on private priority messaging. Private priority messaging may be configured with one or more levels with each level associated with a number of tokens. As illustrated in FIG. 11, an entity 1110 uses an electronic device 1115 to operate an application 1130 as described herein. Tokens may be purchased 1170 by entity 1110. The tokens may be purchased in whole or parts/fraction (such as $10.25 for 25.5 tokens, for example). Entity may browse for a host 1150₁ to follow and may select a desired host 1150. Entity 1110 may enter a priority token value 1140₁ to send a priority message 1175 to the host. The tokens offered for the message are held in escrow 1140₃. The host 1150 receives the message 1190 and responds allowing the tokens to be released from escrow 1140₂. For example, the user enters 1.5 tokens in a separate text box and submits. The message is delivered to the host and along with other messages, they are based on priority off number of tokens submitted 1185.

The sending a message to others in message queue described above may use vote tokens as a premium priority. In this case, the larger the token value, the larger the priority in the message queue. For example, the larger number of vote tokens a message gets enables the message to rise in the priority list. In a situation where a user places 5.5 tokens, that message receives a premium priority over a user who places 2.5 tokens. For example, the user can send their package based on priority where priority one-10 or more, priority two—5-10 tokens, and priority three—under 5 tokens.

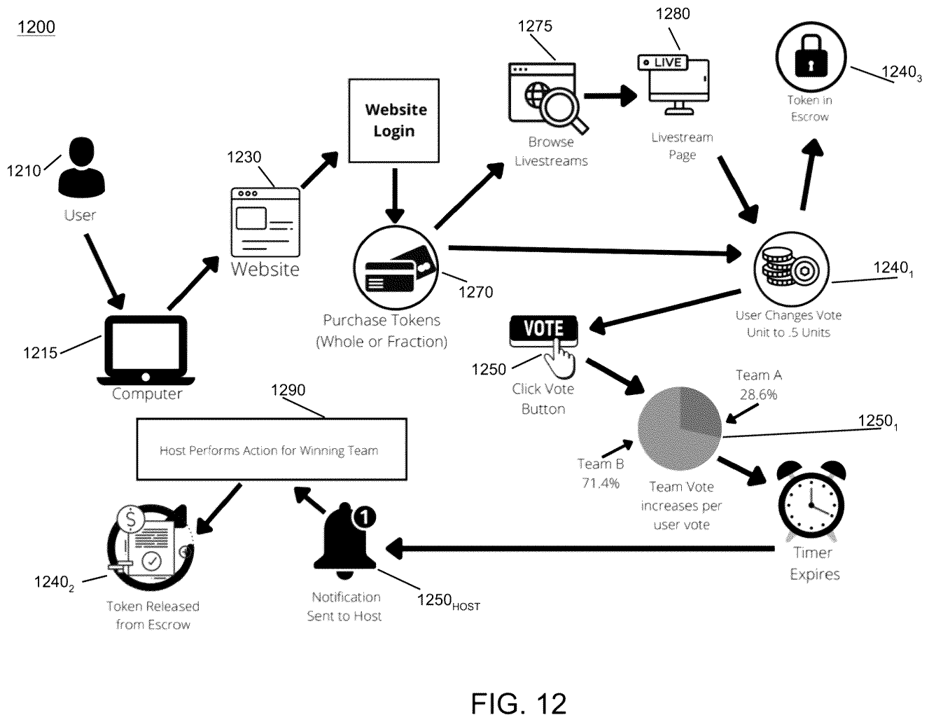

FIG. 12 illustrates a depiction 1200 of a method or flow of the present system using fractional votes based on games and shows. As illustrated in FIG. 12, an entity 1210 uses an electronic device 1215 to operate an application 1230 as described herein. Tokens may be purchased 1270 by entity 1210. The tokens may be purchased in whole or parts/fraction (such as $10.25 for 25.5 tokens, for example). Entity may browse 1275 for existing live stream sessions or pre-recorded video to follow and may select an existing live stream sessions or pre-recorded video page 1280. While the entity 1210 is watching the live stream or pre-recorded video the entity 1210 may enter a token value 1240₁ to vote 1250. The tokens offered for the message are held in escrow. The votes are tabulated 1250₁ and based on the team voting after expiration of a timer notification 1250_{HOST} is sent to the host of the outcome of the voting. The host performs the selected vote task and the token is released from escrow 1240₂. Further, with reference to FIG. 12, announcements may be used instead of voting on actions by providing an announcement link.

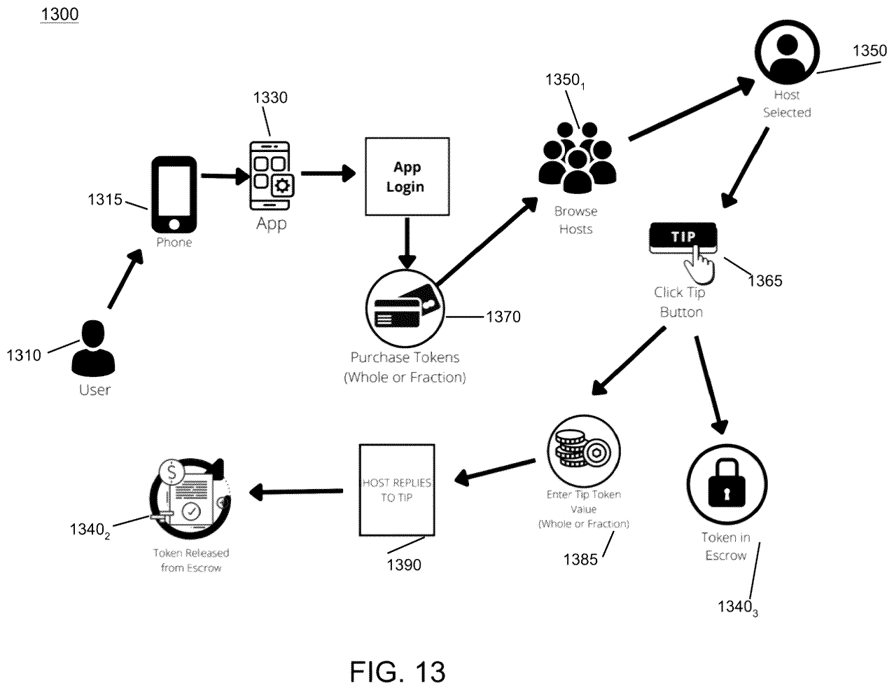

FIG. 13 illustrates a depiction 1300 for a method and flow on a system using fractional votes based on gifts and tips. As illustrated in FIG. 13, an entity 1310 uses an electronic device 1315 to operate an application 1330 as described herein. Tokens may be purchased 1370 by entity 1310. The tokens may be purchased in whole or parts/fraction (such as $10.25 for 25.5 tokens, for example). Entity may browse 1350₁ for a host to follow and may select a host 1350. Entity 1310 may provide a tip by activating a tip button 1365 by entering a token value 1385 with tokens offered for the message are held in escrow 1340₃ until the host performs a particular task associated with the tip The host receives the tip 1390 and the tip is released from escrow 1340₂.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method using fractional votes based on private priority messaging, the method comprising:
entering into an application;
buying tokens in whole or parts;
searching for a host;
selecting the host;
entering a priority token value;
initiating a message for delivery;
delivering the initiated message to the host based on priority token value;
reviewing messages based on priority token value;
placing the priority token value worth of tokens in escrow;
performing a task associated with the message; and
upon successfully responding and completing the task, paying the host a commission.

2. A method using fractional votes using fractional votes based on games/shows, the method comprising:
entering into an application;
buying tokens in whole or parts;
searching for a live stream sessions or pre-recorded video;
selecting the live stream sessions or pre-recorded video;
entering a priority token value;
voting on a particular action to occur in the live stream sessions or pre-recorded video;
placing the priority token value worth of tokens in escrow;
performing the voted action; and
upon successfully completing the action, paying the host a commission.
